(19) United States
(12) Patent Application Publication
(10) Pub. No.: US 2024/0216224 A1
(43) Pub. Date: Jul. 4, 2024

(54) FLAT ROUND TABLET FEEDING SYSTEM FOR UNIGEL CAPSULE PRODUCTION, WITHOUT THE USE OF MEDICINE PREFILLING SYSTEM

(71) Applicants: Carlos Salazar Altamar, Barranquilla (CO); Braulio Fabián Terán Padrón, Barranquilla (CO); Ivan Dario Romero Yepez, Barranquilla (CO); Gustavo Enrique Anaya Romero, Soledad (CO); José Alexander García Guzmán, Barranquilla (CO)

(72) Inventors: Carlos Salazar Altamar, Barranquilla (CO); Braulio Fabián Terán Padrón, Barranquilla (CO); Ivan Dario Romero Yepez, Barranquilla (CO); Gustavo Enrique Anaya Romero, Soledad (CO); José Alexander García Guzmán, Barranquilla (CO)

(21) Appl. No.: 18/401,620

(22) Filed: Dec. 31, 2023

Related U.S. Application Data
(60) Provisional application No. 63/436,612, filed on Jan. 1, 2023.

(51) Int. Cl. A61J 3/07; B65B 5/04; B65B 9/04; B65B 43/08; B65B 47/02; B65B 47/10

(52) U.S. Cl. CPC A61J 3/077; A61J 3/074; B65B 5/04; B65B 9/045; B65B 43/08; B65B 47/02; B65B 47/10

(57) ABSTRACT

The invention provides a process for manufacturing softgel capsules incorporating within said capsule one or more flat round tablets, said process comprising: (i) loading said flat round tablets into a tablet hopper; (ii) feeding said flat round tablets in a vertical orientation into guide channels; (iii) allowing said flat round tablets to move in the vertical orientation along the guide channels by the effect of gravity; (iv) allowing said flat round tablets to pass through a system incorporating a first retention piston and a second delivery piston; (v) allowing said flat round tablets to enter a distributor plate and wedge segment system through the top feed holes in said distributor plate; and (vi) incorporating said flat round tablets into the interior of the softgel capsule.

This application claims the priority benefit under 35 U.S.C. section 119 of U.S. Provisional Patent Application No. 63/436,612 entitled “Flat Round Tablet Feeding System For Unigel Capsule Production, Without The Use Of Medicine Prefilling System” filed on Jan. 1, 2023.

### FIELD OF THE INVENTION

The present invention generally relates to soft gelatin dosage forms for oral administration comprising multiple phases, a manufacturing method and a manufacturing apparatus therefor. More particularly, the present invention relates to multi phase soft gelatin capsules which contain at least one liquid phase and one or more solid phases. The solid and liquid phases may contain active ingredients including active pharmaceutical ingredients (APIs), nutraceuticals, nutritional supplements, therapeutic substances, functional excipients or combinations thereof.

This invention further relates to softgels (or soft gelatin capsules) containing one or more smaller capsules within such capsules and to a process and apparatus for the manufacture thereof. The present invention also relates to a gelatin capsule of the soft type containing multiple active ingredients or the like, and more particularly to a novel gelatin capsule capable of containing multiple medicines or dietary supplement as the content separated from each other, and its manufacturing method and manufacturing apparatus.

The present invention also relates generally to a method and apparatus for forming capsules within capsules containing a measured amount of not compatible medicinals and more particularly to a method and apparatus for forming capsules. The method and apparatus of the present invention are particularly useful in connection with forming softgel capsules having other solid dosage forms containing multiple pharmaceutical product, such as for example medicines, vitamins, food supplements and the like which are not compatible with each other.

The present invention further relates to encapsulation machines and, more particularly, to soft encapsulation machines which make soft gelatin capsules having other smaller capsules within or other solid dosage forms.

The invention is particularly useful for making formulations wherein two active ingredients are not compatible with each other but it is desirable to administer them in the same dosage form i.e., a capsule within a capsule or another solid dosage form within a capsule.

### BACKGROUND OF THE INVENTION

The art of encapsulation has been known for many years, particularly for the production of unit dosage forms containing various pharmaceutical products. Normally, such pharmaceutical capsules are composed of gelatin or some modification thereof, which is fabricated essentially into two different forms, namely, the so-called hard gelatin capsale and the soft gelatin capsule.

It is also known that conventional soft gelatin capsules are a preferred from of administration for medicaments and similar products; especially liquids, pastes, solids dispersed in liquids, or dry solids. Soft gelatin capsules also possess particular advantages for substances which require total protection from air and light, because the gelatin is completely sealed around the contents. An important example is for the encapsulation of vitamins, which has resulted in a high degree of stability thereof.

Hard gelatin capsules are also known in the art, and are generally formed from two distinct parts, namely the “cap” and the “body”, fitting one into the other so as to form the complete capsule. The cap and the body are manufactured by the same process consisting of immersing in a gelatin solution the end of a mandrel whose form corresponds to the inner volume of the cap or of the body, then withdrawing the mandrel from the solution and letting the layer of gelatin thus deposited dry, which is then removed like a glove finger. Hard shell capsules so formed have problems of leakage and do not provide adequate protection from air and light

Soft gelatin capsules, now more commonly known as softgels, have been well known and widely used for many years. Softgels generally comprise an outer shell primarily made of gelatin, a plasticizer, and water, and a fill contained within the shell. The fill may be selected from any of a wide variety of substances that are compatible with the gelatin shell. Softgels are widely used in the pharmaceutical industry as an oral dosage form containing many different types of pharmaceutical and vitamin products. In addition to use as an oral dosage form for drugs and vitamins, soft gelatin capsules or softgels are also designed for use as suppositories for rectal or vaginal use. Other uses are for topical and ophthalmic preparations and the like. The cosmetic industry also uses softgels as a specialized package for various types of perfumes, oils, shampoos, skin creams and the like. Softgels are available in a great variety of sizes and shapes, including round shapes, oval shapes, oblong shapes, tube shapes and other special types of shapes such as stars. The finished capsules or softgels can be made in a variety of colors. Also, opacifiers may be added to the shell.

The process for making softgel capsules includes the step wherein the gelatin shell and the fill material come together to form Softgel capsules. It takes place in a closed environment called clean room where the relative humidity is around 20%. The gelatin shell and fill material are brought together simultaneously in the encapsulation machine.

The process is basically performed as follows: a pump delivers the warm gelatin over two chilled drums which are located at both opposite sides of the machine, through a spreader box that sits over each drum. The warm liquid gelatin flows over the drums and this transforms the liquid gelatin into two solid ribbons of gel. The left and right ribbons pass over rollers which feed them through two die rolls. These die rolls determine the shape and size of softgels and cut the Softgel shell from the ribbons as they turn around.

Simultaneously, a sensitive and high accuracy positive displacement pump delivers the fill material into a heated wedge which sits between rotary dies. This wedge injects the fill material into the die cavities between ribbons just right before the die rolls cut the ribbons and seal the two halves together. Warm just formed softgels slide gently through a chute onto a conveyor belt which carries them to the tumble dryer where cooling and drying process takes place.

In more specific detail, typical soft encapsulation machines form at least two flexible gelatin sheets or ribbons by cooling molten gelatin on separate drums then lubricating and guiding the sheets into communication with each other over co-acting dies while simultaneously dispensing a desired quantity of fill material between the sheets in synch with cavities in the outer surfaces of the dies to produce soft capsules. The encapsulation machines typically utilize gearing to control the relative rotations of the various components and fill mechanisms to synchronize the operation of these various components. The synchronization of these various components, however, can vary depending upon a variety of factors, such as the particular dies used, the number of cavities and the size of the cavities on the dies, and the type of material used to form the sheets. To change the synchronization of the various components, mechanical gears are required to be changed to obtain the desired ratios and synchronization of these components. The changing of gears, however, is time intensive. Additionally, the use of mechanical gears provides finite gear ratios which limit the synchronization of the various components to the mechanical gears that are available. Thus, it would be advantageous to provide a capsule machine wherein the synchronization and rates at which the various components operate can be altered without the necessity of changing gears. Additionally, it would be advantageous if the synchronization between the various components can be infinite to thereby allow more precise synchronization between the various components. It would also be advantageous to allow various components, such as the fill mechanism, to be adjusted independently of the other components while the machine is running to allow for adjustments of the timing of fill material inserted into each of the soft capsules. It would also be advantageous to eliminate the use of casting drums in the making of softgel capsules.

During the operation of the capsule making machine, the contact between the adjacent dies can be adjusted by the operator of the capsule making machine. Typically, the operator is able to move one of the dies closer to the other die so that the pressure or force exerted on the sheets passing between the adjacent dies can be adjusted. Such adjustments, typically are mechanical adjustments made by fluid actuators, such as pneumatic cylinders. The operator is able to adjust the pneumatic pressure thereby altering the force the dies exert on one another and on the sheets. This adjustability allows an operator to customize the pressure to ensure that quality soft capsules are produced. However, the dies are susceptible to premature failure and/or wear when the pressure or force between the two dies is more than that required to produce acceptable soft capsules. Thus, it would be advantageous to monitor/record the pressure applied to the dies so that quality capsules are produced without inducing excessive wear or premature wear on the dies.

A material fill mechanism is used to supply the fill material that is encapsulated within the soft capsules. When the fill material is a liquid, such as a liquid medication or die for a paint ball capsule, the fill mechanism includes a plurality of positive displacement plunger-type pumps that are arranged in a housing above the dies. The plunger-type pumps are positioned on a yoke that moves linearly in a reciprocating motion to allow the plunger-type pump to fill with the liquid fill material on one stroke and subsequently discharge the liquid fill material on the other stroke. A valving arrangement between opposing pumps is utilized to control the discharge and filling of the pumps. The valve arrangement includes a sliding member that moves linearly back and forth in a direction generally perpendicular to the linear motion of the yoke. The discharge of the liquid fill material into the sheets as they are passing through the dies is coordinated with the operation of the dies to insure that the timing of the injection of the liquid fill material is synchronized with the cavities on the dies. Typically, this synchronization has been performed through the use of mechanical gears that link the timing of the stroke to the rotation of the dies. Thus, in order to adjust the synchronization a mechanical gear change is required which is time consuming. Additionally, the timing is limited to a finite number of gear ratios as determined by the gears that are available.

The sliding member of the valving mechanism requires lubrication. Typically, the lubrication is provided by a lubricating pump with its own separate drive. However, the use of a separate drive to operate the lubricating pump adds additional complexity and components to the capsule machine. Thus, it would be advantageous if a motion of the slide member and/or the yoke could be utilized to drive the lubrication pump.

The pumps are typically contained within a housing that is filled with a lubricating oil that is used to lubricate the sliding member. The pumps, however, can leak around their seals and contaminate the lubricating oil with the leaking fill material. Contamination of the oil requires a time consuming and possibly difficult clean up and can cause the lubricating oil to not perform as designed thereby increasing the wear on the sliding surfaces and decreasing the life span of the sliding surfaces. Thus, it would be advantageous to capture any fill material that leaks from the pumps and deter or prevent the liquid fill material from contaminating the lubricating oil within the pump housing.

The pumps are typically driven by a drive mechanism that is also located within the pump housing. Because the drive mechanism is located in the pump housing, it is possible for liquid fill material that leaks from the pumps to contaminate not only the lubrication oil but also the drive mechanism. When switching from one fill material to another, the pump and all of the components in the pump housing are required to be thoroughly cleaned to remove all contamination. The locating of the drive mechanism within the pump housing provides additional components that must also be cleaned when changing the fill material. Thus, it would be advantageous to separate the drive mechanism from the pump housing to reduce the components that are required to be cleaned when changing fill material.

The soft capsules produced by the encapsulation machine are transported from the encapsulation machine to a dryer to additionally dry the soft capsules and to make them into final form. The soft capsules are transported from the encapsulation machine to the dryer by a conveyor that extends along the front of the encapsulation machine. The conveyor can be contaminated by the fill material during operation of the encapsulation machine. When it is desired to switch the product being produced on the encapsulation machine, the conveyor must be removed from the encapsulation machine and cleaned to remove any contaminates thereon. The conveyor is driven by a motor that is attached to the conveyor. When it is necessary to remove the conveyor for cleaning, the motor must also be taken with the conveyor which makes it more difficult to remove and transport the conveyor and requires additional time to disconnect the motor from the encapsulation machine. The present invention provides an encapsulation machine that overcomes the above-described disadvantages of typical encapsulation machines.

The ability to incorporate two or more active ingredients in a single dosage form offers several advantages. The advantages include convenient delivery of multiple medications, avoidance of potential mistakes by user if many medications are to be taken at the same time, increased user compliance, possible synergistic effect and possible controlled delivery.

Various oral medications have been manufactured in the form of soft gelatin capsules. A liquid or semi-solid fill composition is typically encapsulated in soft gelatin capsules using the conventional rotary die method. However, the incorporation of two or more APIs in a soft gelatin capsule can result in chemical incompatibilities or reactions.

Attempts have been made to separate active ingredients to avoid chemical incompatibilities and to maintain the chemical stability of the different active ingredients. Physical barriers may be utilized to separate fill formulations containing different active ingredients. For example, a gelatin partition may be used to divide a soft gelatin capsule into separate chambers with each chamber containing a different fill formulation.

Further attempts have been made to incorporate two or more active ingredients by formulating the fill formulations so that they form different liquid phases or are incompatible. For example, two different fill formulations forming different liquid phases may be layered side-by-side in a soft gelatin capsule. The use of hydrophobic and hydrophilic fill formulations allows for the fill formulations to be layered side-by-side in a soft gelatin capsule. Soft gelatin fill formulations may also be formulated to incorporate API particles suspended in a liquid carrier.

Preformed solid dosage forms may be enrobed with a gelatin coating to permit easier swallowing of the dosage form. Enrobed solid dosage forms may incorporate a second active ingredient in the gelatin coating. A limitation of enrobed solid dosage forms is that they cannot accommodate a liquid phase.

There exists a need for soft gelatin dosage forms capable of providing single ingestion of multiple dosage forms, each having different phases. It is desirable to provide soft gelatin dosage forms containing a solid dosage form and liquid fill phase which maintains the chemical stability of each phase and prevents any chemical reaction between the multiple phases. It is also desirable to incorporate preformed solid dosage forms to retain the established pharmaceutical characteristics of the preformed solid dosage form in combination with a liquid phase, such as physical and chemical stability, active ingredient release profile of the solid dosage form, bioavailability and clinical performance.

Applicant is aware of the following publications briefly discussed below. U.S. Pat. No. 1,970,396 features a method and machine for producing soft gelatin capsules in an automated process. The method involves the formation of two gelatin sheets or films through the use of a gravity fed spreader box, cooling the liquid gelatin on two separate webs, then lubricating and guiding the two sheets into communication with each other between two co-acting dies while simultaneously dispensing the proper amount of medicine or other filling material between the sheets in registration with half cavities in the outer surface of the dies.

U.S. Pat. No. 5,761,886 discloses an apparatus for forming capsules that provides rotary dies that are independently moveable and the ability to vary the speed of the dies during the formation of a single capsule. The '886 device also utilizes independently controlled casting drums to reduce “set-up” time and provide better quality control. Even though the '886 patent discloses a very sophisticated encapsulation machine, it still utilizes a gravity fed spreader box for formation of the encapsulating ribbon.

Other patents relating to encapsulation techniques which disclose the use of spreader boxes to create the film or ribbon on a casting drum include U.S. Pat. Nos. 2,288,327; 2,774,988; 5,246,638; 5,735,105; and 6,022,499.

There exists a need for dosage forms capable of providing single ingestion of multiple dosage forms. It is desirable to provide dosage forms containing at least one solid inclusion and optionally a liquid fill phase which maintains the chemical stability of each inclusion (solid and/or liquid) and prevents any chemical reaction between the multiple inclusions. It is also desirable to incorporate preformed solid inclusions to retain the established pharmaceutical characteristics of the preformed inclusions (optionally in combination with a liquid phase) such as physical and chemical stability, active ingredient release profile of the solid inclusion, bioavailability and clinical performance.

### BRIEF DESCRIPTION OF THE DRAWINGS

FIG. 1 shows the components of the Unigel system for flat tablet feeding.

FIG. 2A is a perspective view of a tablet hopper.

FIG. 2B is a view of the tablet hopper incorporated into the apparatus of the invention showing an internal roller for feeding tablets through the guide channels.

FIG. 3A illustrates the general assembly of the system that includes the hopper, a roller and the pistons and channel guides.

FIG. 3B is an enlarged view of the piston and channel guides.

FIG. 4 features the retention piston system and delivery pistons.

FIG. 5 shows the assembly of distributor plate and wedge segment, with positioning of the flat round tablets, and point of delivery of tablets and injection of liquid medicine.

FIG. 6A illustrates the difference in the design of the segment to work with a medicine prefill system.

FIG. 6B describes illustrates the difference in the design of the segment to work without a medicine prefill system.

FIG. 7 shows the structural difference of the system with a medicine prefill system.

FIG. 8 illustrates the structural difference of the system without a medicine prefill system.

FIG. 9 is a schematic of the channel guide assembly together with the distributor plate and wedge segment.

FIG. 10 represents a view of the conventional softgel manufacturing apparatus incorporating the dispensing device of the invention for incorporating round flats tablets inside a softgel capsule.

### SUMMARY OF THE INVENTION

The invention provides an apparatus for making softgel capsules having incorporated therein other solid dosage forms in the form of round flat tablets and wherein said round flat tablet solid forms are selected from the group consisting of sustained release solid dosage forms, immediate release solid dosage forms, extended release solid dosage forms and zero order release solid dosage forms, said apparatus comprising: (a) two spreader boxes; (b) two casting drums; (c) a pair of rotary dies having means for suction; (d) a liquid fill system; (e) a distributor plate and wedge segment for heating the gelatine ribbons and feeding said fill; and (f) one or two lateral dispensing devices, said lateral dispensing devices including hoppers having said solid dosage forms and retention and delivery pistons, said hopers incorporating a roller and channel guides for transporting said round flat solid dosage forms in a single vertical position and for dispensing said round flat tablet solid dosage form into the softgel pocket formed in the rotary dies.

The invention also provides a dispensing device for dispensing and feeding round flat tablets as solid dosage forms into a softgel capsule said dispensing and feeding device including a hopper having said round flat dosage forms, channel guides for transporting said round flat solid dosage forms and wherein said hopper incorporates a roller and wherein said feeding device provides the round flat solid dosage forms in a single vertical position.

The invention additionally provides a process for manufacturing softgel capsules incorporating within said capsule one or more flat round tablets, said process comprising: (i) loading said flat round tablets into a tablet hopper; (ii) feeding said flat round tablets in a vertical orientation into guide channels; (iii) allowing said flat round tablets to move in the vertical orientation along the guide channels by the effect of gravity; (iv) allowing said flat round tablets to pass through a system incorporating a first retention piston and a second delivery piston; (v) allowing said flat round tablets to enter a distributor plate and wedge segment system through the top feed holes in said distributor plate; and (vi) incorporating said flat round tablets into the interior of the softgel capsule.

### DETAILED DESCRIPTION OF THE INVENTION

As used herein, the terms “active agent,” “active ingredient,” “active pharmaceutical ingredient,” “API,” and “drug” refer to any material that is intended to produce a therapeutic, prophylactic, or other intended effect, whether or not approved by a government agency for that purpose. These terms with respect to specific agents include all pharmaceutically active agents, all pharmaceutically acceptable salts thereof, complexes, stereoisomers, crystalline forms, co crystals, ether, esters, hydrates, solvates, and mixtures thereof, where the form is pharmaceutically active. In certain embodiment, the term“active ingredient” may refer to a material intended to produce a cosmetic effect (with or without a therapeutic effect), whether or not approved by a government agency for that purpose.

As used herein, the term “stereoisomers” is a general term for all isomers of individual molecules that differ only in the orientation of their atoms in space. It includes enantiomers and isomers of compounds with one or more chiral centers that are not mirror images of one another (diastereomers).

The term “enantiomer” or “enantiomeric” refers to a molecule that is nonsuperimposable on its mirror image and hence optically active wherein the enantiomer rotates the plane of polarized light in one direction by a certain degree, and its mirror image rotates the plane of polarized light by the same degree but in the opposite direction.

The term “chiral center” refers to a carbon atom to which four different groups are attached. “Pharmaceutically acceptable salts” include, but are not limited to, inorganic acid salts such as hydrochloride, hydrobromide, sulfate, phosphate and the like; organic acid salts such as formate, acetate, trifluoroacetate, maleate, tartrate and the like; sulfonates such as methanesulfonate, benzenesulfonate, p-toluenesulfonate and the like; amino acid salts such as arginate, asparaginate, glutamate and the like; metal salts such as sodium salt, potassium salt, cesium salt and the like; alkaline earth metals such as calcium salt, magnesium salt and the like; and organic amine salts such as triethylamine salt, pyridine salt, picoline salt, ethanolamine salt, triethanolamine salt, discyclohexylamine salt, N,N′-dibenzylethylenediamine salt and the like.

The present invention is directed to the secondary encapsulation of at least one round flat tablet using a rotary die process. An apparatus and process for manufacturing dosage forms capable of encapsulating at least one round flat tablet and optionally a liquid fill are disclosed. In dosage forms that encapsulate at least one round flat tablet and a liquid fill, the solid phase and the liquid phase may be independently introduced into the dosage form. The at least one round flat tablet and the liquid fill (if present) may contain active ingredients including APIs, nutritional supplements, or substances for therapeutic or cosmetic (e.g., non-pharmacologic action) purposes.

The dosage forms of the present invention are capable of delivering multiple medications or therapeutic substances in a single dose. The dosage forms of the present invention may be formulated to provide different or identical release profiles for the various medications or therapeutic substances therein. Exemplary release profiles may include, without limitations, immediate release, extended release, delayed release and so on. The secondary encapsulation of at least one round flat tablet in dosage forms disclosed herein permits retention of established pharmaceutical characteristics of the round flat tablet and of the liquid fill (if present).

In some embodiments where there is more than one dispensing device, the at least round flat tablet in the first dispensing device may comprise one type of API, nutritional supplement or substance used for therapeutic or cosmetic (e.g., non-pharmacologic action) purposes. The at least one round flat tablet in each additional dispensing device(s) may be an identical API, nutritional supplement or substance used for therapeutic or cosmetic (e.g., non-pharmacologic action) purposes as in the first dispensing tube. Alternatively, the at least one round flat tablet in each additional dispensing tube(s) may be a different API, nutritional supplement or substance used for therapeutic or cosmetic (e.g., non-pharmacologic action) purposes from the round flat tablet in the first dispensing device.

The liquid fill or semi-solid fill of the capsule (if present) may comprise one or more liquids or semi-solids that are compatible with the capsule shell and do not interfere with or degrade the round flat tablet. The liquid fill or semi-solid fill may comprise one or more combinations of fluids that may be broadly categorized as hydrophilic or lipophilic.

A lipophilic liquid fill or semi-solid fill may be an oil form of an active ingredient, an active ingredient or multiple active ingredients preparation that may be solutions, suspensions, emulsions, micro-emulsions, self-emulsifying systems, gels, and other liquids or semi-solids that will be known to those who are expert in the field of capsule formulations. Examples of useful oils include omega-3 fatty acids triglycerides (e.g., alpha-linolenic acid, eicosapentaenoic acid and docosahexaenoic acid), ethyl esters, vegetable oils, mineral oils or other food grade oil. Vegetable oils may include castor bean oil, coconut oil, peanut oil, palm kernel oil, canola oil, avocado oil, evening primrose oil, rice bran oil, borage oil, sunflower oil, soybean oil, palm oil, corn oil and safflower oil.

Hydrophilic liquid fill or semi-solid fill are typically based on polyethylene glycols commonly referred to as PEG and may include lesser amounts of glycerol, propylene glycol and water. Other hydrophilic materials used to a lesser extent include, but not limited to, methoxypolyethylene glycols, diethyleneglycol monoethyl ether tetrahyrofurfuryl alcohol polyethylene glycol, propylene carbonate, n-methyl-2-pyrrolidone, polyoxyethylene-poly-oxypropylene copolymers benzyl alcohol and ethyl alcohol.

The fill formulation may be prepared using established procedures employed for manufacture of pharmaceutical solutions, suspensions and semi-solids.

Individual or multiple liquid phases (if present) may be introduced into the capsule by means of a single, dual or multiple wedge design that facilitates in-situ capsule filling of multiple phases.

The liquid fill (if present) may include different liquid phases which are layered side-by-side in the softgel capsule. Each layered phase may incorporate an active ingredient or multiple active ingredients.

The fill materials may also include excipients known in the art of capsule encapsulation such as dispersants, surfactants, plasticizers, flavoring agents, opacifying agents, preservatives, embrittlement inhibiting agents, colorants, dyes and pigments, and disintegrants.

Typical immediate release coating films that may be used on the round flat tablets to be encapsulated in the capsule or on the shell of a capsule are hydro-alcoholic film coatings or cellulose film coating systems as used in various pharmaceutical solid oral dosage forms. Typical coating systems may be aqueous, alcohol or organic solvent based or combinations containing hydroxy-propyl-methyl cellulose and derivatives, and polyvinyl alcohol and derivatives. Examples of film coated dosage forms that could be used as the round flat tablets to be encapsulated include, without limitations, Amoxicillin, Azithromycin, Atenolol, Amlodipine, Acelofenac, Amtriptyline, AmpicillinHCI, Ciprofloxacin, Cefadroxil HCl, Celecoxib, Cimetidine, Calcium Tablets, Certizine HCl, Clarithromycin, Chloroquine Phosphate, Erythromycin estolate, Erythromycin striate, Enalpril Maleate, Elctronxib, Ferrous, fumarate, Famotidine, Flupenthixol, Fluoxetine Felodipine, Gatifloxacin, Gliclazide, Ibuprofen, lndap-amide, Ketorolac, Ketoprofen, Levofixation, Levocetrinzie, Losartan, Potassium, Levamisole, Metormin, Methylopa, Metra+Tetraozole, Metronidozole, Methyl, Comblamine, Mefenamic acid, Metropralal Nifedipne, Norfloxacin, Nifedopine, Norfloxacin, Norflax+Tindazole, Oflaxacin, Oflaxacin+Omidazole, Olazzapine, Orridazole, Oflexacin+Omid-azole Paracetamol, Pravastain, Prmethazine, Quinine, sulphate, Primaquine, Ramipril, Tindazole, Tiri+Doxicycline, Tiri+Tetracyline, Valdecoxib, Verapamil, herbal and Neutraceuticals.

Typical protective coatings that may be used on the round flat tablets to be encapsulated in the capsule or on the shell of a capsule may include, but are not limited to, polymer, antioxidants, chelating agents, colours or dyes.

Typical enteric coatings that may be used on the round flat tablets to be encapsulated in the capsule or on the shell of a capsule comprise, but are not limited to, one or more of the following recognized coating agents: methyl acrylate-methacrylic acid copolymers, cellulose acetate succinate, hydroxy propyl methyl cellulose phthalate, hydroxy propyl methyl cellulose acetate succinate (hypromellose acetate succinate), polyvinyl acetate phthalate (PVAP), methyl methacrylate-methacrylic acid copolymers, sodium alginate/alginic acid and stearic acid. Examples of enteric coated dosage forms (e.g., tablets, beads, capsules) include: Aspirin and Clopidogrel combination, Aspirin, Bisacodyl, Diclofenac-sodium, Doxylamine succinate, Esomeprazole, Garlic Tablets, Lansoprazole, Omeparazole, Pantoprazole, Pentoxyfilline, Pancreatin, Rabeprazole, Serratiopeptidase, and Sodium Valproate.

Sustained release solid inclusions and/or capsules may be film coated, enteric coated, or polymer matrix formulated. Sustained release film coatings may include, but are not limited to, a water insoluble material such as a wax or wax-like substance, fatty alcohols, shellac, zein, hydrogenated vegetable oils, water insoluble celluloses, polymers of acrylic and/or methacrylic acid, and any other slowly digestible or dispersible solids known in the art. Examples of sustained release dosage forms that could be used as the solid inclusions to be encapsulated include, without limitations: Acetazolamide Pellets, Aminophylline, Amitriptyline Pellets, Captoprill, Diclofenac Sodium, Diltiazem, Gliclazide, Iron, Levodopa, Lithium Carbonate, Metformin, Methyldopa, Nifedipine, Salbutamol Sulphate, Theophylline, Verapamil HCL, vitamin supplements, mineral supplements, and vitamins with Zinc.

Suitable active ingredients introduced in the round flat tablets to be encapsulated in the capsule and/or in a liquid fill (if present) and/or semi-solid fill (if present) may comprise APIs, nutritional supplements, substances used for therapeutic or cosmetic (e.g., non-pharmacologic action) purposes, functional excipients or combinations of active ingredients and functional excipients that control or otherwise affect the release of the active ingredient(s) into the gastrointestinal tract or site of absorption. If different phases are present in a capsule (e.g., a round flat tablet and a liquid fill or a semi-solid fill), each phase may contain one or more active ingredient(s). The active ingredient(s) in the different phases may be the same or different.

The present invention contemplates the use of any active ingredients known in the art. It is well within the knowledge of a skilled person in the art to select a particular combination of active ingredients or medicaments. In some embodiments, active ingredients may include, but are not limited to, the following: APIs, nutraceuticals, nutritional supplements, therapeutic substances, cosmetic ingredients (e.g., non-pharmacologic action) such as glycine and DHA, and functional excipients.

Suitable APIs may include, but are not limited to, the following: analgesics, anti inflammatory agents, anti-helminthics, anti-arrhythmic agents, anti-asthma agents, anti-bacterial agents, anti-viral agents, anti-coagulants, anti-dementia agents, anti-depressants, anti-diabetics, anti-epileptics, anti-fungal agents, anti-gout agents, anti-hypertensive agents, anti-malarials, anti migraine agents, anti-muscarinic agents, anti-neoplastic agents, immunosuppressants, anti protozoal agents, anti-pyretics anti-thyroid agents, anti-tussives, anxiolytics, sedatives, hypnotics, neuroleptics, neuroprotective agents, beta-blockers, cardiac inotropic agents, cell adhesion inhibitors, corticosteroids, cytokine receptor activity modulators, diuretics, anti-Parkinson's agents, gastrointestinal agents, histamine H-receptor antagonists, HMG-CoA reductase inhibitors, keratolytics, lipid regulating agents, muscle relaxants, nitrates and other anti-anginal agents, non steroid anti-asthma agents, nutritional agents, opioid analgesics, sex hormones, stimulants, and anti-erectile dysfunction agents.

Suitable nutraceuticals may include, but are not limited to, 5-hydroxytryptophan, acetyl L-camitine, alpha lipoic acid, alpha-ketoglutarates, bee products, betaine hydrochloride, bovine cartilage, caffeine, cetyl myristoleate, charcoal, chitosan, choline, chondroitin sulfate, coenzyme Q10, collagen, colostrum, creatine, cyanocobalamin (Vitamin 812), dimethylamino-ethanol, fumaric acid, germanium sequioxide, glandular products, glucosamine HCl, glucos-amine sulfate, hydroxyl methyl butyrate, immunoglobulin, lactic acid, L-Camitine, liver products, malic acid, maltose-anhydrous, mannose (d-mannose), methyl sulfonyl methane, phytosterols, picolinic acid, pyruvate, red yeast extract, S-adenosylmethionine, selenium yeast, shark cartilage, theobromine, vanadyl sulfate, and yeast.

Suitable nutritional supplements may include vitamins, minerals, fiber, fatty acids, amino acids, herbal supplements or a combination thereof.

Suitable vitamins may include, but are not limited to, the following: ascorbic acid (Vitamin C), B vitamins, biotin, fat soluble vitamins, folic acid, hydroxycitric acid, inositol, mineral ascorbates, mixed tocopherols, niacin (Vitamin B3), orotic acid, para-aminobenzoic acid, panthothenates, panthothenic acid (Vitamin B5), pyridoxine hydrochloride (Vitamin B6), riboflavin (Vitamin B2), synthetic vitamins, thiamine (Vitamin B1), tocotrienols, vitamin A, vitamin D, vitamin E, vitamin F, vitamin K, vitamin oils and oil soluble vitamins.

Suitable herbal supplements may include, but are not limited to, the following: arnica, bilberry, black cohosh, cat's claw, chamomile, echinacea, evening primrose oil, fenugreek, flaxseed, feverfew, garlic, ginger root, ginko biloba, ginseng, goldenrod, hawthorn, kava-kava, licorice, milk thistle, psyllium, rauowolfia, senna, soybean, St. John's wort, saw palmetto, turmeric, valerian. Minerals may include, but are not limited to, the following: boron, calcium, chelated minerals, chloride, chromium, coated minerals, cobalt, copper, dolomite, iodine, iron, magnesium, manganese, mineral premixes, mineral products, molybdenum, phosphorus, potassium, selenium, sodium, vanadium, malic acid, pyruvate, zinc and other minerals.

In the context of the present invention, the term UNIGEL refers to processes and products comprising softgel capsules incorporating other smaller solid forms within said softgel capsule. The other solid forms include other smaller capsules, tablets, pellets, round tablets and other pharmaceuticals solid forms.

The invention provides a tablet feeding device designed for the manufacture of products in the UNIGEL presentation, which allows the use of flat round tablets. The same feeding system allows the encapsulation of these products to be carried out without the need to use the medicine pre-filling system that the UNIGEL process requires to eliminate the air bubble that is inherently formed during the encapsulation process.

In the UNIGEL system, the feeding of flat round tablets is more difficult during transport to the capsule formation system, since this type of flat tablets do not slide like spherical tablets, and therefore jamming occurs. in feeding channels. Additionally, the conventional UNIGEL system requires an additional medicine prefilling subsystem to be able to displace, before the capsules are sealed, the air microbubbles that are trapped during the injection of the medicine.

In order to achieve the inclusion of this type of flat tablets within the soft capsule without using the prefill system, a subsystem was designed, manufactured and put into operation, which is adapted to the same conventional machine both in its structural design, as well as in its principles of operation and functioning.

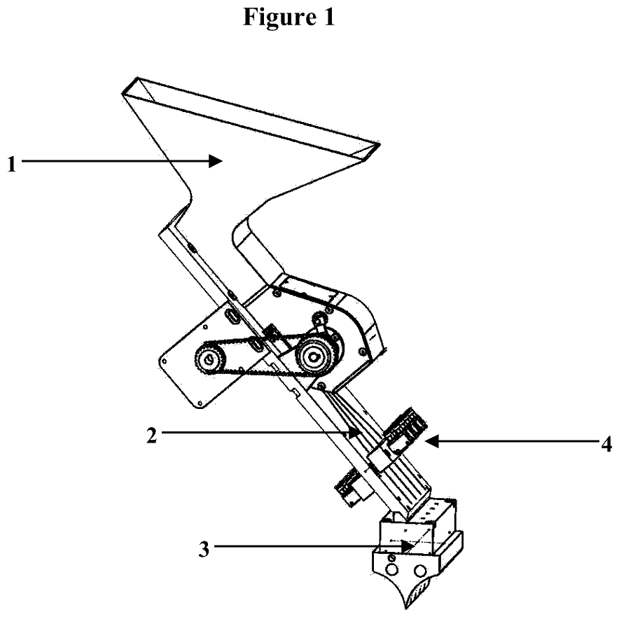

A general scheme of the invention is illustrated in FIG. 1. Referring FIG. 1, the components of the Unigel system for flat tablet feeding includes a tablet hopper 1, a feed channel guide 2 for flat round tablets, a distributor plate and segment 3, and a set of retention pistons system 4.

The components of this system, with its differentiated design compared to the conventional UNIGEL system, have the following functions:

### Tablet Hopper:

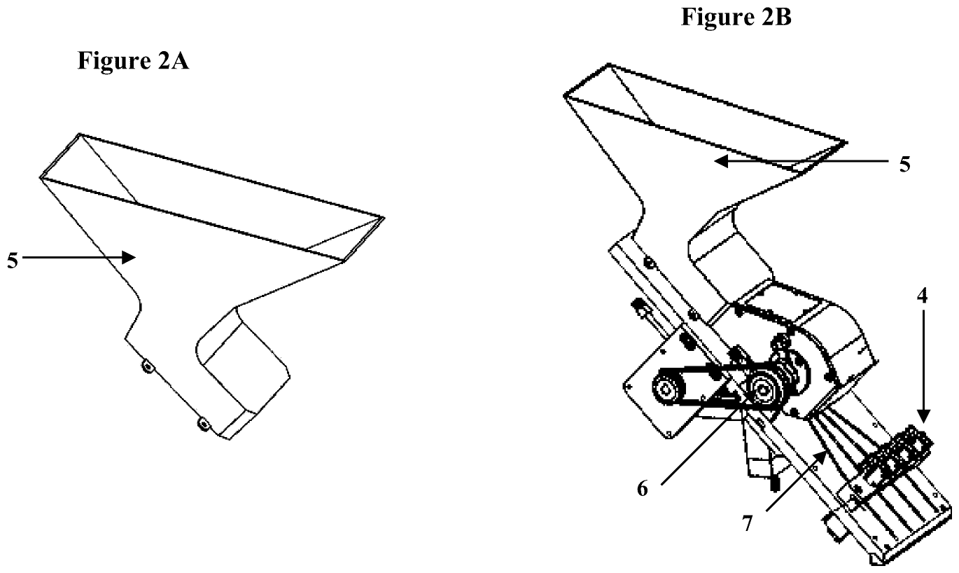

This hopper fulfills the function of temporarily storing the load of tablets to be encapsulated, slowing down their feeding rate to the channels of the guide system. It has a roller inside that has a controlled speed and that is in charge of delivering the flat round tablets into the feeding channels. The tablet hopper is located in the upper part of the feeding channel guide for flat round tablets, and the transport of the tablets towards the delivery point of the channels is generated by the effect of gravity. FIG. 2A illustrates the tablet hoper 5 while FIG. 2B shows the tablet hopper 5 mounted on the apparatus and having an internal roller 6 for feeding the flat round tablets through the channels 7 at controlled speeds.

### Feed Channel Guide for Flat Round Tablets:

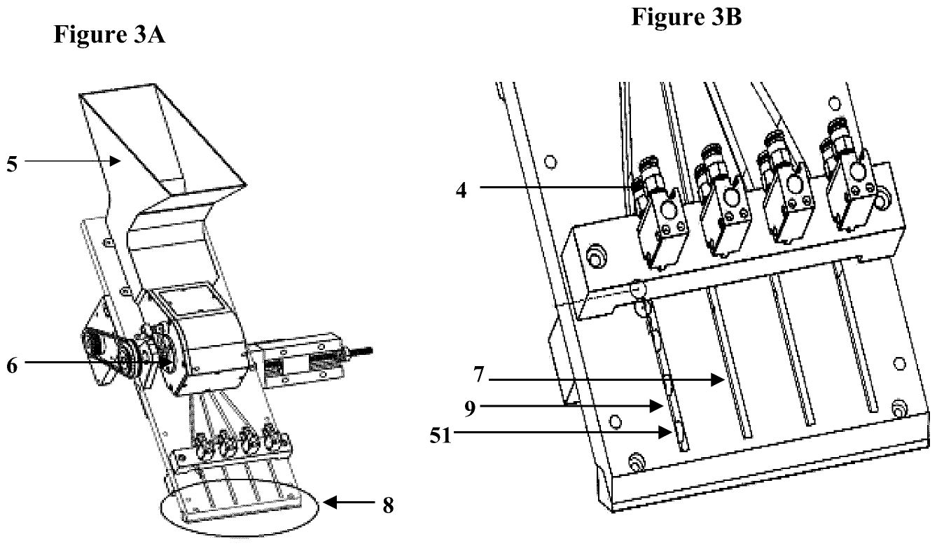

The function of the feeding channel guide is to guarantee the transport and delivery of the flat round tablets to each of the cavities of the mold, in the encapsulation process. The feeding channels of the present invention have a special design that allows the positioning and displacement of the flat round tablets from the tablet hopper to the distributor plate and segment system. Its design is made based on the size of the flat round tablets to be included inside the softgel, and the size and shape of the outer softgel. The flat round tablets move through the feeding channels due to the effect of gravity, but this movement is mainly achieved thanks to the design profile of the cross section of each of the feeding channels defined for this invention, which allows the positioning and transport of the flat round tablets, without generating clogging, up to their point of delivery in the orifices of the distributor plate and segment. The guide is located between the tablet hopper and the distributor plate and segment system, as can be seen in FIG. 1. FIG. 3A and FIG. 3B shows a detailed images of the component, including its assembly in the system, and an enlarged detail that shows the design and positioning characteristics of the flat round tablets, required for correct operation, of the system.

As shown in FIG. 3A the system includes a flat round tablet hopper 5 and a roller 6 having variable speed. The section labeled with reference numeral 8 is part of the channel guides and piston assembly in enlarged detail in FIG. 3B.

FIG. 3B shows an enlarged detail of the feeding channels 7 and 9 and retaining and delivery pistons 4 as well as the vertical position of the tablets 51 in the channel.

### Tablet Retention and Delivery Piston System:

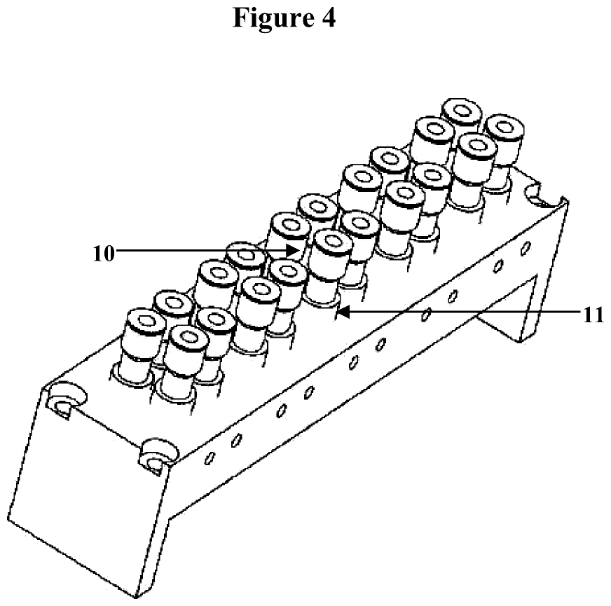

FIG. 4 is a view of the retention and delivery pistons of the assembly. As shown in FIG. 4, reference numeral 10 denotes the retention pistons and reference numeral 11 denotes the delivery pistons. The pistons are a multiple system, whose function is to dose the fall of the flat round tablets into the soft capsules, and to avoid the accumulation of tablets in the final section of the channels of the feeding guide, which could cause an overdose of the required number of tablets within the same capsule. Each feed channel of the guide has a system of two pistons aligned on it, and separated from each other the minimum distance necessary to fit one flat round tablet between them. The first piston—retention—retains the row of tablets that comes down the feeding channel and delivers them, one by one, to the second piston; The second piston delivery—in its upward movement delivers one tablet to the distributor plate and segment system, and in its downward movement it retains the next tablet to be delivered. In this way, the delivery of 1 tablet per channel is guaranteed in each cycle. The tablet delivery and retention pistons are located on a plate attached to the feed channel guide for flat round tablets, as illustrated in FIG. 1.

### Distributor Plate and Segment:

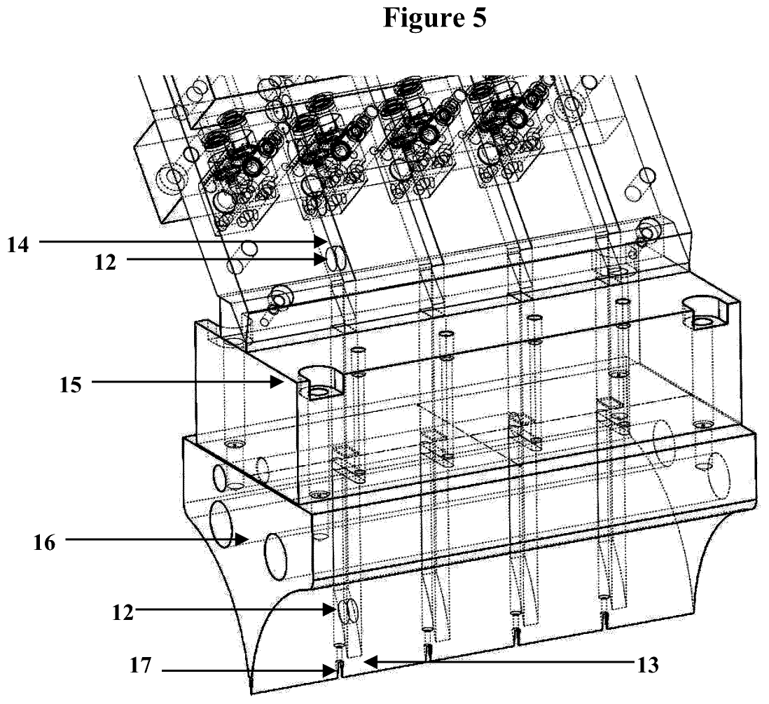

The distributor plate and segment system in the encapsulation machines has as basic objectives the supply of heat so that the gelatin films reach the glass transition temperature for the sealing of the capsules, as well as the supply of the liquid inside the soft capsules. The system is connected to a positive displacement pump from which the dose and injection time of the liquid are controlled. In the case of UNIGEL, this system fulfills the additional function of supplying the tablets inside the soft capsules. In the case of this patent, the segment has a design with internal feeding channels, which are through-passing and allow the transport of the flat round tablets that come from the feeding channel guide, dosed through the retention piston system. The design of these through channels has special characteristics of dimension and orientation that allow the flat round tablet to fall in a single position, to be delivered from below, through the face of the segment that is in contact with the gelatin film. As an effect of this positioning, the gelatin film picks up the flat round tablet and keeps it inside while it moves to the apex of the segment to reach the injection point of the medicine, but allowing air to remaining trapped in the gelatin film at the time of collecting the tablet, reach out through the same through channel of the segment without the need to use the medicine prefill system to displace the bubble. The system is located after the feed channel guide, on top of the molds, as shown in FIG. 1. FIG. 5 illustrates the assembly of the distributor plate on the segment, coupled to the feed channel guide to round tablets. The figure also illustrates the positioning of the flat round tablets within the feeding channel, as well as their position within the segment, and shows the delivery point of the tablets on the lateral face of the segment, close to the injection point of the liquid medicine by the vertex.

As shown in FIG. 5, reference numeral 12 denotes flat round tablets moving through feeding channel guide 14. Reference numeral 15 illustrates the distributor plate 15 mounted on top of the wedge segment 16. Reference numeral 13 shows the delivery of flat round tablets and also liquid injection of other medicines through element 17.

In one aspect of the invention, the system for secondary encapsulation of at least one round flat tablet in a capsule may comprise a first rotating encapsulation die comprising a first set of die cavities and a second rotating encapsulation die comprising a second set of die cavities. The apparatus may further comprise a continuous first film on the first rotating encapsulation die and a continuous second film on the second rotating encapsulation die. The apparatus may further comprise a distributor plate and wedge segment between the first rotating encapsulation and the second rotating encapsulation die. The apparatus may further comprise a dispensing system that transports the round flat tablets in a vertical position integrated into the wedge and positioned off-center in the wedge such that the dispensing device is aligned with a first row of cavities in the first rotating encapsulation die and with a second row of cavities in the second rotating encapsulation die for dispensing at least one round flat tablet. The apparatus may further comprise a mechanical dispensing mechanism and a synchronization mechanism for synchronizing the rotating of at least one of the first rotating encapsulation die or the second rotating encapsulation die with the mechanical dispensing of the at least one round flat tablet such that the at least one round flat tablet is timely trapped between the continuous first film and the wedge in a cavity within the first set of die cavities to form a first half of a capsule.

Mechanically dispensing at least one round flat tablet may be performed through various mechanical dispensing mechanisms, such as, with a dispensing plunger, with an actuator (e.g., electromagnetic, rotary screw driven, cam driven, hydraulically driven, pneumatically driven and so on), with a pump in a batch configuration, with a pump in a continuous or semi-continuous configuration and so on.

### Stages of the Process:

Referring to FIG. 3A, flat round tablets are loaded into the tablet hopper 5. This hopper has a roller 6 inside that has a variable controlled speed, and that is in charge of distributing the flat round tablets into the feed channels of the guide, slowing down their feeding rate, and allowing the flat round tablets to enter the channels in a single vertical position like a wheel that allows their subsequent displacement on the guide. The speed of the roller is controlled by a servomotor, whose ignition is activated depending on the level of fullness of the hopper 5.

When the flat round tablets are positioned in a vertical position and enter the feeding channels of the guide, they move along these channels due to the effect of gravity. This displacement effect is achieved thanks to the special design of the channels, and the positioning of the tablets in the transition between the tablet hopper and the feeding channel guide. The dimension and quantity of the channels is designed based on the cavities of the mold of the encapsulating machine, and thanks to this design, the proper positioning of the tablets is maintained throughout their transport on the guide.

FIG. 3B is an enlarged drawing of the structural element 8 of FIG. 3A. The tablets 51 pass through the retention piston system 4. When the first (retention) piston goes up, the second (delivery) piston goes down; and the distance between both pistons is calculated according to the size of the tablet, so that only 1 tablet is accommodated between both pistons. Then the retention piston lowers, retaining the row of tablets in a previous step, while the delivery piston rises and allows the fall of the retained tablet, towards the distributor plate and segment system not shown. The opening and closing cycle is repeated, allowing the dosage of the tablets, one by one, in each channel and for each one of the cavities of the mold. This cycle is synchronized with the speed of the encapsulation machine, ensuring that the delivery of the round flat tablets at the point of delivery coincides with the moment the softgel is formed in the mold cavities.

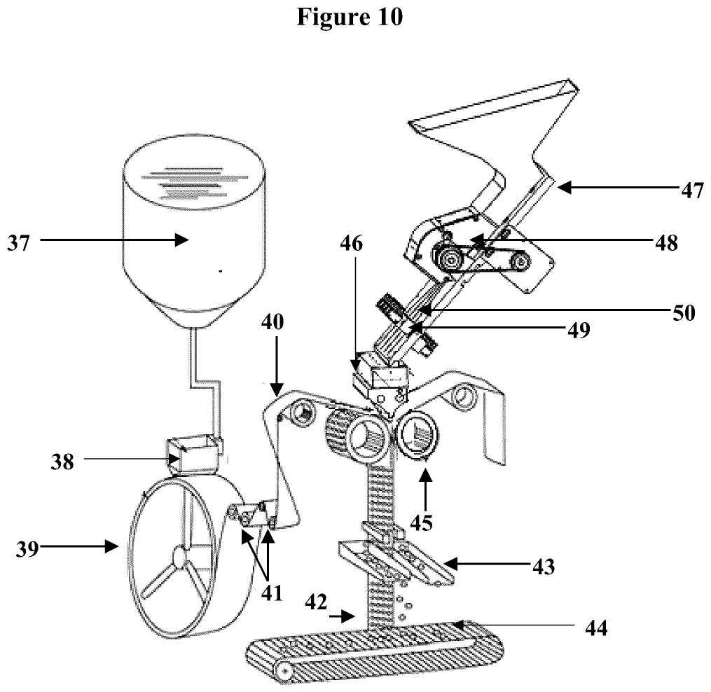

As shown in FIG. 5, tablets 12 enter the distributor plate and wedge segment system through the top feed holes. Due to the special internal design of the wedge segment, the tablets are positioned laterally, parallel to the front face of the segment, and free fall through the tablet dispensing channel. The special design of these through channels allows the drop of the flat round tablet in a single position, to be delivered from below, through the face of the segment that is in contact with the gelatin film. Thanks to this position at the delivery point, the gelatin film that is moving on that side of the segment picks up the flat round tablet and keeps it inside, while it moves to the apex of the segment, to reach the injection point of medicine. Due to the design of the through channel and the orientation of the tablet position, the remaining air-trapped in the gelatin film when the tablet is picked up—manages to escape through the same through channel of the segment, without the need to use the system. medicine prefill to displace the bubble. See further FIG. 10 for more details regarding the integrated manufacturing process.

The tablets already contained between the gelatin film and the lateral face of the segment move towards the lower vertex of the segment, up to the injection point of the liquid medicine. The delivery time of the tablets inside the mold cavities is synchronized with the speed of rotation of the encapsulation machine and with the liquid medicine dosing pump. In this way, when the mold rotates, the tablets remain inside the cavities, inside the capsules, without air bubbles inside.

The differences of this system with the conventional Unigel system are:
(a) Redesign of the feeding guides for flat round tablets.
(b) Redesign of the segment for flat round tablets.
(c) Combination of designs to eliminate the medicine prefill system.

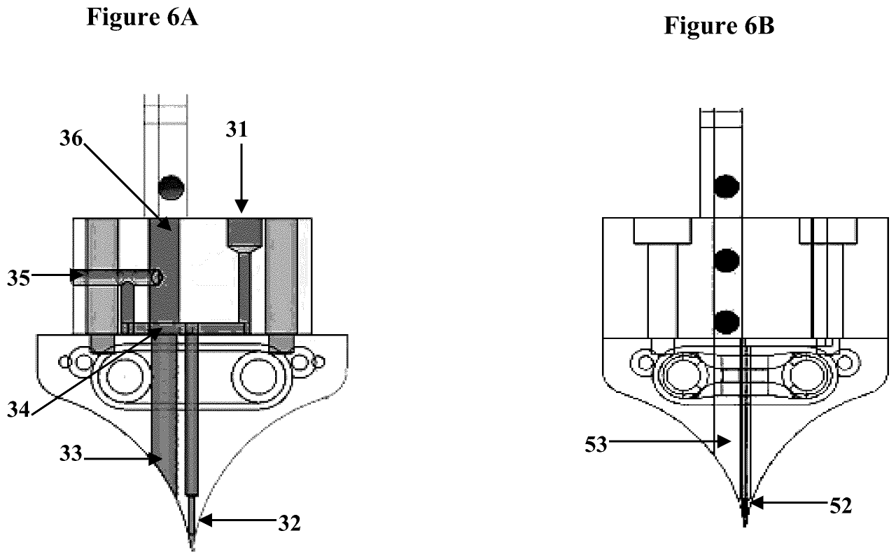

FIGS. 6A and 6B illustrates the difference in the design of the wedge segment to work with a medicine prefill system and to work without a medicine prefill system.

As shown in FIG. 6A, the distributor plate and segment system includes a filling medicine inlet 31, a fill medicine outlet 32, an output of solids and pre-fill medicine 33, a solids feed channel and pre-fill medicine 34, a pre-filling medicine inlet 35 and a solids input 36.

FIG. 6B is the wedge segment design without a prefill system incorporating a liquid injecting means 52 and a solid delivery device 53.

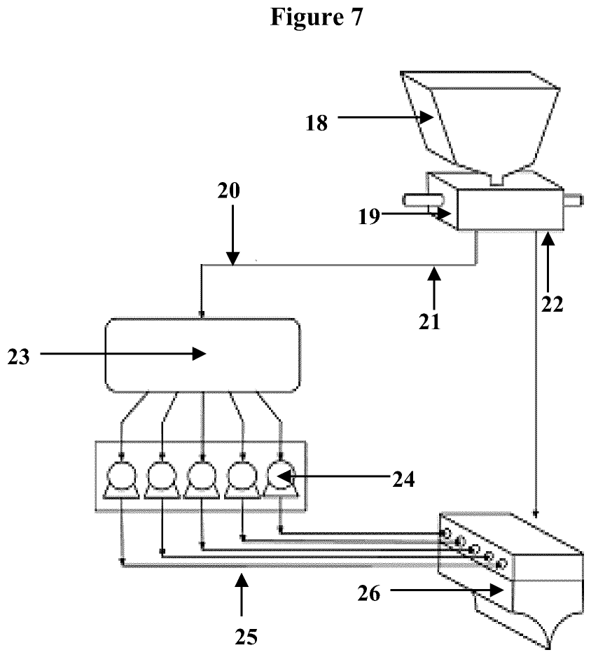

FIG. 7 shows the structural difference of the system with a medicine prefill system.

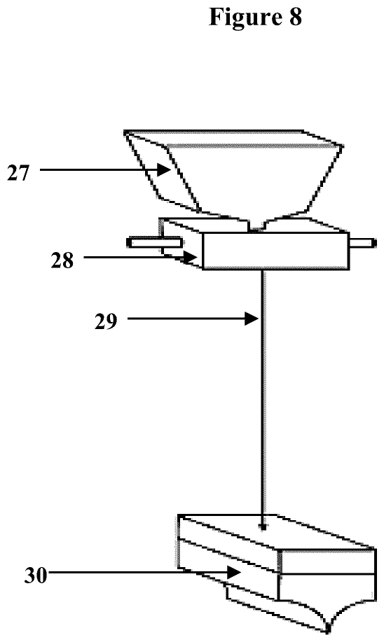

FIG. 8 shows the structural difference of the system without a medicine prefill system.

FIGS. 7 and 8 are a schematic comparison between the prior art with a medicine prefill system, and the proposed art without a medicine prefill system.

The conceptual scheme of the prefill system is illustrated schematically in FIG. 7. Referring to FIG. 7 describing the pre-filling system for carrying out the invention, reference numeral 18 is a hopper containing a medicine comprising a pharmaceutical active and reference numeral 19 represents a dosing pump. The dosing pump includes a pre-filling system outlet 21, a filling system outlet 22 and a feeding hose 20 providing medicine to the pre-fill medicine dispenser 23. The system further includes pre-filling pumps 24, dosing hoses 25 and a distributor plate and segment 26.

The medicine hopper 18 and dosing pump 19 are conventional dosing pumps and medicine hoppers that are used in softgel capsule manufacturing. In general, piston pumps are used through which the total filling of the capsule is metered as a function of the diameter and the stroke of the pistons. However, within the scope of the invention any type of pumping system that is used to fill the capsules can be utilized.

The supply hose 20 is a feeding hose for the amount of pre-fill medicine required for the total number of capsule samples that the mold of the encapsulating machine will have that is required to be dosed. The hose 20 leads the pre-fill medicine from the dosing pump to the pre-fill medicine dispenser 23.

The pre-fill medicine dispenser 23 is a device that consists of a chamber that, through a single inlet, receives the pre-fill medicine sent by the dosing pump 19 through the feeding hose 20. Through a design of internal channels, this device distributes the received medicine in a homogeneous and equitable way, and doses it through several outlets, each of which will feed pre-fill pumps 24. The number of outlets will depend on the mold and the product being encapsulated.

The pre-fill pumps 24 are a set of high precision pumps, which receive the medicine from the pre-fill medicine dispenser 23. They are in charge of sending the pre-fill through the dosing hoses 25, towards the distributor plate system of the segment 26. In general, rotary piston pumps are used, special for small doses. However, within the scope of the invention, this system includes any type of pumping system that is used to pre-fill the capsules.

The dosing hoses 25 receive the pre-fill medicine delivered by the pre-fill pump system 24 and transport it to the distributor plate and segment system 26. Each hose will feed one channel of the distributor plate.

The distributor plate and segment system 26 is aimed at supplying heat so that the gelatin films reach the glass transition temperature for sealing the capsules, as well as supplying the liquid inside the soft capsules. In the case of the pre-filling system 21 for displacement of the bubbles, this system fulfills the additional function of supplying the solids inside the soft capsules, while supplying, on the one hand, the pre-filling dose that will displace the air bubble, and on the other hand, the remaining content that each capsule must carry, to complete 100% of the nominal theoretical dosage of the product to be encapsulated. The system is designed with internal feed channels in addition to the conventional design, which are through and allow the dosage of the pre-fill medicine, the fill medicine, and the passage of solids into the Unigel softgels.

The system without prefill is illustrated in FIG. 8, and it consists of a medicine hopper 27, a dosing pump 28, a filling system 29, and a distributor plate and wedge segment 30.

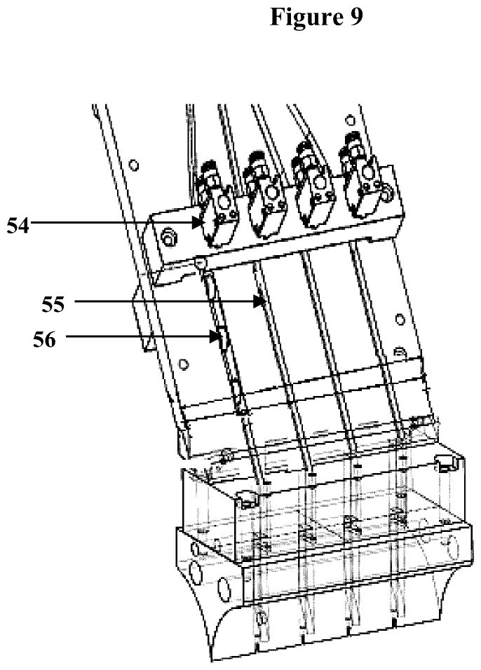

FIG. 9 is a schematic of the channel guide assembly together with the distributor plate and wedge segment. The schematic shows the delivery and retention pistons 54, the channel guides 55 and the flat round tablets 56 moving through the channel guide.

FIG. 10 represents a view of the conventional softgel manufacturing apparatus incorporating the dispensing device of the invention for incorporating round flats tablets inside a softgel capsule. In FIG. 10, reference numeral 37 represents a tank containing gelatin which transferred to a spreader box 38 which is used to cast the gelatin film into a cooling drum 39 to make the film ribbon 40 which passed through oil rollers 41 and then goes through the rotating dies 45 having vacuum means to make pockets which are then filled with the round flat tablets via the wedge segment and distributor plate 46. The round flat tablets are transported to the wedge and distributor plate starting at the hopper 47 which includes a roller 48. The flat round tablets are transported via gravity through channel guides 50 and then deposited through the wedge segment 46 using a retention and delivery piston assembly 49.

All patents, patent applications and publications cited in this application including all cited references in those applications and publications, are hereby incorporated by reference in their entirety for all purposes to the same extent as if each individual patent, patent application or publication were so individually denoted.

While the many embodiments of the invention have been disclosed above and include presently preferred embodiments, many other embodiments and variations are possible within the scope of the present disclosure and in the appended claims that follow. Accordingly, the details of the preferred embodiments and examples provided are not to be construed as limiting. It is to be understood that the terms used herein are merely descriptive rather than limiting and that various changes, numerous equivalents may be made without departing from the spirit or scope of the claimed invention.

What is claimed is:

1. An apparatus for making softgel capsules having incorporated therein other solid dosage forms in the form of round flat tablets and wherein said round flat tablet solid forms are selected from the group consisting of sustained release solid dosage forms, immediate release solid dosage forms, extended release solid dosage forms and zero order release solid dosage forms, said apparatus comprising:
(a) two spreader boxes;
(b) two casting drums;
(c) a pair of rotary dies having means for suction;
(d) a liquid fill system;
(e) a distributor plate and wedge segment for heating the gelatine ribbons and feeding said fill; and
(f) one or two lateral dispensing devices, said lateral dispensing devices including hoppers having said solid dosage forms and retention and delivery pistons, said hopers incorporating a roller and channel guides for transporting said round flat solid dosage forms in a single vertical position and for dispensing said round flat tablet solid dosage form into the softgel pocket formed in the rotary dies.

2. A dispensing device for dispensing and feeding round flat tablets as solid dosage forms into a softgel capsule said dispensing and feeding device including a hopper having said round flat dosage forms, channel guides for transporting said round flat solid dosage forms and wherein said hopper incorporates a roller and wherein said feeding device provides the round flat solid dosage forms in a single vertical position.

3. A process for manufacturing softgel capsules incorporating within said capsule one or more flat round tablets, said process comprising:
(i) loading said flat round tablets into a tablet hopper;
(ii) feeding said flat round tablets in a vertical orientation into guide channels;
(iii) allowing said flat round tablets to move in the vertical orientation along the guide channels by the effect of gravity;
(iv) allowing said flat round tablets to pass through a system incorporating a first retention piston and a second delivery piston;
(v) allowing said flat round tablets to enter a distributor plate and wedge segment system through the top feed holes in said distributor plate; and
(vi) incorporating said flat round tablets into the interior of the softgel capsule.

4. The apparatus of claim 1, wherein said round flat tablet contains active pharmaceutical ingredients.

5. The apparatus of claim 4, wherein said active pharmaceutical ingredient is selected from the group consisting analgesics, anti inflammatory agents, anti-helminthics, anti-arrhythmic agents, anti-asthma agents, anti-bacterial agents, anti-viral agents, anti-coagulants, anti-dementia agents, anti-depressants, anti-diabetics, anti-epileptics, anti-fungal agents, anti-gout agents, anti-hypertensive agents, anti-malarials, anti migraine agents, anti-muscarinic agents, anti-neoplastic agents, immunosuppressants, anti protozoal agents, anti-pyretics anti-thyroid agents, anti-tussives, anxiolytics, sedatives, hypnotics, neuroleptics, neuroprotective agents, beta-blockers, cardiac inotropic agents, cell adhesion inhibitors, corticosteroids, cytokine receptor activity modulators, diuretics, anti-Parkinson's agents, gastrointestinal agents, histamine H-receptor antagonists, HMG-CoA reductase inhibitors, keratolytics, lipid regulating agents, muscle relaxants, nitrates and other anti-anginal agents, non steroid anti-asthma agents, nutritional agents, opioid analgesics, sex hormones, stimulants, and anti-erectile dysfunction agents.

6. The apparatus of claim 1, wherein said round flat tablet contains nutraceutical ingredients.

7. The apparatus of claim 6, wherein said nutraceutical is selected from the group consisting of 5-hydroxytryptophan, acetyl L-camitine, alpha lipoic acid, alpha-ketoglutarates, bee products, betaine hydrochloride, bovine cartilage, caffeine, cetyl myristoleate, charcoal, chitosan, choline, chondroitin sulfate, coenzyme Q10, collagen, colostrum, creatine, cyano-cobalamin (Vitamin 812), dimethylamino-ethanol, fumaric acid, germanium sequioxide, glandular products, glucosamine HCl, glucos-amine sulfate, hydroxyl methyl butyrate, immunoglobulin, lactic acid, L-Camitine, liver products, malic acid, maltose-anhydrous, mannose (d-mannose), methyl sulfonyl methane, phytosterols, picolinic acid, pyruvate, red yeast extract, S-adenosylmethionine, selenium yeast, shark cartilage, theobromine, vanadyl sulfate, and yeast.

8. The apparatus of claim 1, wherein said round flat tablet contains a nutritional supplements selected from the group consisting of vitamins, minerals, fiber, fatty acids, amino acids, herbal supplements or a combination thereof.

9. The apparatus of claim 8, wherein said vitamin is selected from the group consisting of ascorbic acid (Vitamin C), B vitamins, biotin, fat soluble vitamins, folic acid, hydroxycitric acid, inositol, mineral ascorbates, mixed tocopherols, niacin (Vitamin B3), orotic acid, para-aminobenzoic acid, panthothenates, panthothenic acid (Vitamin B5), pyridoxine hydrochloride (Vitamin B6), riboflavin (Vitamin B2), synthetic vitamins, thiamine (Vitamin B1), tocotrienols, vitamin A, vitamin D, vitamin E, vitamin F, vitamin K, vitamin oils and oil soluble vitamins.

10. The dispensing device of claim 2, wherein said round flat tablet contains active pharmaceutical ingredients.

11. The dispensing device of claim 10, wherein said active pharmaceutical ingredient is selected from the group consisting analgesics, anti inflammatory agents, anti-helminthics, anti-arrhythmic agents, anti-asthma agents, anti-bacterial agents, anti-viral agents, anti-coagulants, anti-dementia agents, anti-depressants, anti-diabetics, anti-epileptics, anti-fungal agents, anti-gout agents, anti-hypertensive agents, anti-malarials, anti migraine agents, anti-muscarinic agents, anti-neoplastic agents, immunosuppressants, anti protozoal agents, anti-pyretics anti-thyroid agents, anti-tussives, anxiolytics, sedatives, hypnotics, neuroleptics, neuroprotective agents, beta-blockers, cardiac inotropic agents, cell adhesion inhibitors, corticosteroids, cytokine receptor activity modulators, diuretics, anti-Parkinson's agents, gastrointestinal agents, histamine H-receptor antagonists, HMG-CoA reductase inhibitors, keratolytics, lipid regulating agents, muscle relaxants, nitrates and other anti-anginal agents, non steroid anti-asthma agents, nutritional agents, opioid analgesics, sex hormones, stimulants, and anti-erectile dysfunction agents.

12. The dispensing device of claim 2, wherein said round flat tablet contains nutraceutical ingredients.

13. The dispensing device of claim 12, wherein said nutraceutical is selected from the group consisting of 5-hydroxytryptophan, acetyl L-camitine, alpha lipoic acid, alpha-ketoglutarates, bee products, betaine hydrochloride, bovine cartilage, caffeine, cetyl myristoleate, charcoal, chitosan, choline, chondroitin sulfate, coenzyme Q10, collagen, colostrum, creatine, cyano-cobalamin (Vitamin 812), dimethylamino-ethanol, fumaric acid, germanium sequioxide, glandular products, glucosamine HCl, glucos-amine sulfate, hydroxyl methyl butyrate, immunoglobulin, lactic acid, L-Camitine, liver products, malic acid, maltose-anhydrous, mannose (d-mannose), methyl sulfonyl methane, phytosterols, picolinic acid, pyruvate, red yeast extract, S-adenosylmethionine, selenium yeast, shark cartilage, theobromine, vanadyl sulfate, and yeast.

14. The dispensing device of claim 2, wherein said round flat tablet contains a nutritional supplements selected from the group consisting of vitamins, minerals, fiber, fatty acids, amino acids, herbal supplements or a combination thereof.

15. The dispensing device of claim 14, wherein said vitamin is selected from the group consisting of ascorbic acid (Vitamin C), B vitamins, biotin, fat soluble vitamins, folic acid, hydroxycitric acid, inositol, mineral ascorbates, mixed tocopherols, niacin (Vitamin B3), orotic acid, para-aminobenzoic acid, panthothenates, panthothenic acid (Vitamin B5), pyridoxine hydrochloride (Vitamin B6), riboflavin (Vitamin B2), synthetic vitamins, thiamine (Vitamin B1), tocotrienols, vitamin A, vitamin D, vitamin E, vitamin F, vitamin K, vitamin oils and oil soluble vitamins.

16. The process of claim 3, wherein said round flat tablet contains active pharmaceutical ingredients.

17. The process of claim 16, wherein said active pharmaceutical ingredient is selected from the group consisting analgesics, anti inflammatory agents, anti-helminthics, anti-arrhythmic agents, anti-asthma agents, anti-bacterial agents, anti-viral agents, anti-coagulants, anti-dementia agents, anti-depressants, anti-diabetics, anti-epileptics, anti-fungal agents, anti-gout agents, anti-hypertensive agents, anti-malarials, anti migraine agents, anti-muscarinic agents, anti-neoplastic agents, immunosuppressants, anti protozoal agents, anti-pyretics anti-thyroid agents, anti-tussives, anxiolytics, sedatives, hypnotics, neuroleptics, neuroprotective agents, beta-blockers, cardiac inotropic agents, cell adhesion inhibitors, corticosteroids, cytokine receptor activity modulators, diuretics, anti-Parkinson's agents, gastrointestinal agents, histamine H-receptor antagonists, HMG-CoA reductase inhibitors, keratolytics, lipid regulating agents, muscle relaxants, nitrates and other anti-anginal agents, non steroid anti-asthma agents, nutritional agents, opioid analgesics, sex hormones, stimulants, and anti-erectile dysfunction agents.

18. The process of claim 3, wherein said round flat tablet contains nutraceutical ingredients.

19. The process of claim 18, wherein said nutraceutical is selected from the group consisting of 5-hydroxytryptophan, acetyl L-camitine, alpha lipoic acid, alpha-ketoglutarates, bee products, betaine hydrochloride, bovine cartilage, caffeine, cetyl myristoleate, charcoal, chitosan, choline, chondroitin sulfate, coenzyme Q10, collagen, colostrum, creatine, cyano-cobalamin (Vitamin 812), dimethylamino-ethanol, fumaric acid, germanium sequioxide, glandular products, glucosamine HCl, glucos-amine sulfate, hydroxyl methyl butyrate, immunoglobulin, lactic acid, L-Camitine, liver products, malic acid, maltose-anhydrous, mannose (d-mannose), methyl sulfonyl methane, phytosterols, picolinic acid, pyruvate, red yeast extract, S-adenosylmethionine, selenium yeast, shark cartilage, theobromine, vanadyl sulfate, and yeast.

20. The The process of claim 3, wherein said round flat tablet contains a vitamin selected from the group consisting of ascorbic acid (Vitamin C), B vitamins, biotin, fat soluble vitamins, folic acid, hydroxycitric acid, inositol, mineral ascorbates, mixed tocopherols, niacin (Vitamin B3), orotic acid, para-aminobenzoic acid, panthothenates, panthothenic acid (Vitamin B5), pyridoxine hydrochloride (Vitamin B6), riboflavin (Vitamin B2), synthetic vitamins, thiamine (Vitamin B1), tocotrienols, vitamin A, vitamin D, vitamin E, vitamin F, vitamin K, vitamin oils and oil soluble vitamins.
